(19) United States
(12) Patent Application Publication
(10) Pub. No.: US 2025/0283379 A1
(43) Pub. Date: Sep. 11, 2025

(54) DRONE-BASED METHOD OF SUBTERRANEAN DIRECTIONAL DRILLING CONTROL

(71) Applicant: HAZEN INTERNATIONAL ENERGY SERVICES INC., Lake Country (CA)

(72) Inventors: Malcom Douglas McGregor, Lake Country (CA); Troy Martin, Lake Country (CA); Warren Barrow, Lake Country (CA)

(21) Appl. No.: 18/859,825

(22) PCT Filed: Apr. 25, 2023
(86) PCT No.: PCT/CA2023/050559

§ 371 Date: Oct. 24, 2024

(30) Foreign Application Priority Data
Apr. 25, 2022 (CA) 3156467

(51) Int. Cl. E21B 7/04; E21B 44/00; E21B 47/01; E21B 47/092; G01V 3/165

(52) U.S. Cl. CPC E21B 7/04; E21B 44/00; E21B 47/01; E21B 47/092; G01V 3/165

(57) ABSTRACT

The invention comprises a method of controlling the position of a subterranean directional drilling tool in relation to a desired subterranean drill bore path using a system including a directional drilling tool capable of drilling within an associated subterranean drill bore, the drilling tool having a control bus capable of receiving control inputs to control the operational drilling direction of the tool. Embodiments may also include a magnetic tool target attached to the drilling tool for emission of a detectible magnetic field. Embodiments may also include at least one UAV capable of controllably hovering or landing at a above-ground sensing location and including a tri-axial magnetometer capable of detecting the magnetic field emitted by the magnetic tool target and yielding detected magnetic field data from which the distance and position of the drilling tool in relation to the UAV can be determined.

### FIELD OF THE INVENTION

This invention is in the field of magnetic ranging methods, and more specifically pertains to a method for use in locating and directing a directional drilling tool using an above surface magnetometer attached to a drone permitting use in sensitive and inaccessible locations.

### BACKGROUND

Magnetic range detection methods are used in many industrial applications. A key subterranean operating application in which magnetic ranging is useful is in the field of horizontal drilling or similar tool operations. In such applications, typically involving the use of directional boring machines and similar tools, the need to have extremely accurate understanding of the position of a drilling tool and the drill bore beneath the earths surface, water body floor surface etc. is important, both from the perspective of optimized bore positioning and avoidance of pre-existing anomalies, related or unrelated bores, pipelines or the like.

A typical magnetic ranging application relies upon two components, the first being a target signal generator being a magnet of varying types which is capable of generating a detectible magnetic field. The target signal generator is integrated to the drilling tool or otherwise positioned in relation to the tool face etc. to permit the generation of the detectible target magnetic field from the tool position which is desired to be measured or calculated using the method and system. Active magnetic ranging used in tool positioning applications typically relies upon AC magnets, as known magnetic sources less affected by background changes. In some applications passive magnetic ranging using DC magnets is also used.

The second component of a magnetic ranging system of this type in a typical directional drilling application is a receiver comprising a multi-axis magnetometer capable of the detection of the target magnetic field generated by the signal generator. Typically using a tri-axial magnetometer, the receiver is capable of determining the position of the target signal generator in relation to the receiver by detecting and calculating the position of the magnetic signal source in relation to the receiver which has a known position-provided the high accuracy of the sensor and receiver working in conjunction with the target signal generator, the calculated positioning of the drilling tool in a directional drilling application is highly accurate, leading to the ability to alter the tool drilling path and the like for various reasons. Enhanced drilling accuracy and velocity are both results of this type of an approach which are significant in commercial attraction.

A key variable or factor in magnetic ranging methods such as this using a target signal generator and a multiaxis magnetometer is understanding the position of the receiver, from which position the location of the target signal generator will be relatively calculated or determined. The accuracy of the se two-part magnetic ranging methods relies upon sufficient proximity between the target signal generator and the magnetometer/receiver since the sensor can only accurately sense for calculation of the position of the tool for a specific accuracy range from the magnet, as the magnet and the tool move away from the receiver.

In earthbound applications, as the magnet and a s sociated drilling tool etc. move out of the optimal operating range of the magnetometer, the magnetometer can be repositioned in a new fixed and relatable optimal earthbound position and the position detection calculations adjusted for the new location, resulting in the continued ability to accurately determine the positioning of the associated drilling tool in relation to the magnetometer and/or the head end of the drilling tool etc.

Addressing limitations in the range of the calculation method, particularly in more complicated drilling environments underwater for example, is a significant limitation in current methods and if it were possible to come up with an alternate approach to directional drilling tool positioning in the context of drilling beneath watercourses, it is believed that this would be positively received.

Many prior art applications of this nature rely upon manually positioned surface-based magnetometers, which significantly inhibits the speed and accuracy of these methods or even the utility of same in certain applications, particularly in applications where human ingress and egress from particular locations is difficult or impossible. In sensitive surface environmental areas, areas of rugged terrain or even areas including water, marshland or the like, it is difficult or impossible for human operators to easily access the location and as such the limited ability to detect from the closest or most ideal location the magnetic field emanating from the operating drilling tool limits the accuracy of the method as the sensitive or rugged area is traversed. If it were possible to position the surface-based magnetometer without the need for human operators this would be a significant enhancement in the method, again resulting in significantly enhanced accuracy and velocity of directional drilling applications of this nature.

There is no current use of a surface-based magnetometer for tracking the progress of a rotating magnet in a horizontal drilling system. In such a case it would be ideal to use a UAV/drone to hover or land over a “no access” location to capture the necessary measurements. The captured measurements and data could be processed on board the drone or raw data could be transmitted via many different types of wireless communications to another location for data processing. The ability to rapidly assess and calculate the specific terrestrial underground position of the drilling tool will allow for computerized navigation of the tool in proximity to the de sired wellbore path.

### BRIEF SUMMARY

The present invention is directed towards determining the precise location of a subterranean drilling tool, by securely placing a vector measuring magnetometer at an above surface location in proximity to the desired path of the wellbore and detecting a rotating or stationary magnetic field whose position is known by acceptable survey methods. The magnetometer will be manipulated in relation to a sensing location by attachment to a UAV which could hover or land in respect of a particular desired hard-to-reach location.

The method of the invention would also be practiced using software for the processing of captured relative and fixed positional data. The software could be executable on onboard processing equipment on the UAV and the results of the calculations transmitted back to a computer for viewing or further use, or the UAV and its associated tool sensors could transmit raw data back to a computer hosting said software for facilitation of the remainder of the method. Both such approaches are contemplated within the scope of the present invention. Captured measurements and data could be processed on board the drone or raw data could be transmitted via many different types of wireless communications to another location for data processing.

As outlined above and throughout, the directional drilling tool itself would be equipped with a magnetic tool target, namely a magnet capable of emitting a detectable magnetic field which can be used to determine the relative location of the magnetic tool target in relation to a magnetometer sensing same.

The terrestrially referenced location of the drilling tool and other related information could be displayed to an operator of the directional drilling equipment for the purpose of adjusting or directing the drilling tool, or in other cases automated control inputs could also be provided to the drilling tool. High speed and highly accurate drilling can be achieved using this method.

This UAV-based approach could be used in areas where it is not convenient to physically position a surface-based receiver on the surface such as overwater, on highways and roads, very busy or difficult areas including on or in relation to lakes, rivers and streams etc., or even in the case of marshes and swamps. In other cases, the system and method of the present invention will also be extremely effective in relation to step terrain such as hills and cliffs or the like, or sensitive land, high density trees etc. The drone-based measurement system of the present invention could be useful not only in dangerous or hard to access locations but could also save time and accelerate measurement even on a rapid easy across ground movement. This type of an approach is also contemplated explicitly within the scope of the present invention.

The invention comprises a method of controlling the position of a subterranean directional drilling tool in relation to a desired subterranean drill bore path using a system including a directional drilling tool capable of drilling within an associated subterranean drill bore, the drilling tool having a control bus capable of receiving control inputs to control the operational drilling direction of the tool.

Embodiments may also include a magnetic tool target attached to the drilling tool for emission of a detectible magnetic field.

Embodiment s may also include at least one UAV capable of controllably hovering or landing at a above-ground sensing location and including a tri-axial magnetometer capable of detecting the magnetic field emitted by the magnetic tool target and yielding detected magnetic field data from which the distance and position of the drilling tool in relation to the UAV can be determined. Certain embodiments of the system and method of the present invention could use a single UAV which would move between sensing locations as the tool moved in the subterranean drill bore. In other embodiments, multiple UAVs could be used, each of which would send data to the computer for incorporation into the mathematical re solution attracting of the tool, to allow for enhanced speed or accuracy of the method. Both such approaches are contemplated within the scope of the present invention.

Typically each UAV would include a GPS receiver capable of receiving GPS signals identifying the terrestrial location of the UAV, being UAV position data. Embodiments may also include a network interface. In some embodiments, detected magnetic field data and UAV position data can be transmitted to a computer in operative communication with the control bus of the tool. In other embodiments, rather than transmitting binary or other electronic control inputs directly to the drilling tool, drilling tool instructions or interface elements could be displayed to an operator for manual actuation. Both such approaches are contemplated within the scope of the present invention.

Embodiments may also include a computer including a processor. Embodiment s may also include a memory storing the terrestrial drilling coordinate s of the desired subterranean drill bore path. Embodiments may also include a network interface capable of communication with the at least one UAV and receiving data transmitted therefrom.

Embodiments may also include a control bus connection to the control bus of the drilling tool. The system and method of the present invention could either provide digital control inputs to the control bus of the drilling tool allowing for automated control, or in other cases the control inputs which might be provided to a control bus would be user-interface indications, provided to a visual display or the like, permitting a manual operation of the drill tool by human operator. Both such approaches will be understood to be within the scope of the present invention.

Embodiments may also include a positioning software component including processor instructions. In some embodiments, the computer can facilitate the necessary steps of the method.

The method including would include, using the system, actuating the drilling tool to drill in estimated accordance with the stored terrestrial drilling coordinates.

In operation and execution of the method, each of the at least one UAV would be controllably positioned at a selected sensing location in proximity to the intended alignment of the desired subterranean drill bore path, within detection range of the magnetic tool target by the magnetometer. During operation and rotation of the drilling tool, the magnetic field created and emitted thereby be detected by the magnetometer borne by the UAV and in respect of each UAV, the detected magnetic field data in relation to the magnetic tool target captured using the magnetometer, and the terrestrial location of the UAV using the UAV-based GPS receiver, would be transmitted to the detected magnetic field data and UAV position data to the computer.

Upon receipt of a data transmission from one of the at least one UAVs at the computer via the network interface of the UAV at the computer, the method could next include a location resolving step whereby on receipt of detected magnetic field data by the computer from any of the UAVs, the computer would receive or calculate the relative target location of the magnetic tool target in relation to the corresponding magnetometer using the received detected magnetic field data. The relative target location would then be mathematically combined with the UAV position data to yield a terrestrially referenced location of the drilling tool.

Following the determination of a terrestrially referenced location of the drilling too, that location would be compared to the stored terrestrial drilling coordinates of the de sired subterranean drill bore path, by the software component, and to the extent that it was determined that the path of movement of the drilling tool was deviating from the desired subterranean drill bore path any necessary change in operating drilling direction of the drilling tool to maintain the terrestrial drilling position of the tool as closed to the desired drill bore path as possible could be determined.

If any change in drilling direction may be required, the software in the computer could provide an associated control input to the control bus of the drilling tool, to allow for automated or manual adjustment of the drilling direction of the tool.

The computer could also periodically actuate movement of each UAV to a new desireable sensing position along the drill bore path as the drilling tool advances. During operation of the system the periodic detection of the drilling tool position and adjustment of the operating drilling direction will result in an optimized adherence of the drilling tool to the de sired subterranean drill bore path.

In some embodiments, the number of UAVs may be one. In some embodiments, the number of UAVs may be more than one.

In some embodiments, the magnetometer may be rigidly attached to the corresponding UAV. In some embodiments, the magnetometer may be flexibly suspended from the corresponding UAV by a cable.

In some embodiments, where the subterranean drill bore is beneath the water course or a body of water, the UAV with a cable suspended magnetometer could lower the magnetometer below the surface of the water course at the selected sensing location to be as close as possible to the tool and maximize the accuracy of detection of its position.

In some embodiments, the network interface of a UAV via which data may be transmitted to the computer may be either an integrated network interface of the UAV, or a separate network interface module as sociated with the magnetometer and borne by the UAV.

In some embodiments, the position of the magnetic tool target and the tri-axial magnetometer on the at least one UAV may be switched whereby each UAV includes a magnetic tool target for emission of a detectible magnetic field and the drilling tool includes a tri-axial magnetometer capable of detecting the magnetic field emitted by the magnetic tool target of the at least one UAV, the magnetometer being connected to the computer to transmit detected magnetic field data thereto. In such a switched embodiment, in the location resolving step of the method, on receipt of detected magnetic field data by the computer from the tool-borne magnetometer, the software will calculate the relative target location of the magnetic tool target in relation to the magnetometer using the received detected magnetic field data and mathematically combine the UAV position data with the relative target location to yield a terrestrially referenced location of the drilling tool.

In one embodiment the invention comprises a system for controlling the position of a subterranean directional drilling tool in relation to a desired subterranean drill bore path including a directional drilling tool capable of drilling within an associated subterranean drill bore, the drilling tool having a control bus capable of receiving control input s to control the operational drilling direction of the tool. A magnetic tool target is attached to the drilling tool for emission of a detectible magnetic field.

Embodiments of the system of the present invention also comprise at least one UAV capable of controllably hovering or landing at a above-ground sensing location and including a tri-axial magnetometer capable of detecting the magnetic field emitted by the magnetic tool target and yielding detected magnetic field data from which the distance and position of the drilling tool in relation to the UAV can be determined.

Each UAV would also typically include a GPS receiver capable of receiving GPS signals identifying the terrestrial location of the UAV, being UAV position data. A UAV network interface could communicate with a remote computer for the purpose of execution of the method. Detected magnetic field data and UAV position data can be transmitted to a computer in operative communication with the control bus of the tool.

Embodiments may also include a computer including a processor and a memory storing the terrestrial drilling coordinate s of the de sired subterranean drill bore path. Computer will also include a network interface capable of communication with the at least one UAV and receiving data transmitted therefrom.

Computer will also include a control bus connection to the control bus of the drilling tool and a positioning software component including processor instructions to facilitate the necessary steps of the method.

The system as outlined will execute the method as outlined in alternate embodiments hereof, specifically including actuating the drilling tool to drill in estimated accordance with the stored terrestrial drilling coordinates. The computer would transmit appropriate sensing location coordinates to each UAV and each UAV could then be positioned at a selected sensing location in proximity to the intended alignment of the desired subterranean drill bore path, within detection range of the magnetic tool target by the magnetometer. The system could then on an ongoing or periodic basis capture, in respect of each UAV, detected magnetic field data in relation to the magnetic tool target using the magnetometer and the terrestrial location of the UAV using the UAV-based GPS receiver, and transmit the detected magnetic field data and UAV position data to the computer.

On receipt of detected magnetic field data by the computer from any of the UAVs, the software component would calculate the relative target location of the magnetic tool target in relation to the corresponding magnetometer using the received detected magnetic field data, and mathematically combine the UAV position data with the relative target location to yield a terrestrially referenced location of the drilling tool.

The terrestrially referenced location of the drilling tool would then be compared to the stored terrestrial drilling coordinate s of the desired subterranean drill bore path and any necessary change in operating drilling direction of the drilling tool to maintain the terrestrial drilling position of the tool as closed to the desired drill bore path a s possible would be determined. If any change in drilling direction may be required, providing an associated control input to the drilling tool via the control bus.

The computer could periodically actuate movement of each UAV to a desireable sensing position along the drill bore path as the drilling tool advances.

During operation of the system the periodic detection of the drilling tool position and adjustment of the operating drilling direction will result in an optimized adherence of the drilling tool to the desired subterranean drill bore path.

One or more UAVs may be used in the system.

In some embodiments, the magnetometer may be rigidly attached to the corresponding UAV. In some embodiments, the magnetometer may be flexibly suspended from the corresponding UAV by a cable.

Where the drilling tool is being used beneath the water course, the UAV with a cable suspended magnetometer could lower the magnetometer below the surface of the water at the selected sensing location to maximize the accuracy and efficiency of the method.

In some embodiments, the position of the magnetic tool target and the tri-axial magnetometer on the at least one UAV may be switched wherein each UAV includes a magnetic tool target for emission of a detectible magnetic field and the drilling tool includes a tri-axial magnetometer capable of detecting the magnetic field emitted by the magnetic tool target of the at least one UAV, the magnetometer being connected to the computer to transmit detected magnetic field data thereto.

In addition to the system and method claimed and disclosed, the software component installed on the computer and capable of executing the steps of the method as outlined herein is also understood to be intended to be within the scope of the present invention.

### BRIEF DESCRIPTION OF THE FIGURES

FIG. 1 is a side schematic diagram of one embodiment of the system in accordance with the present invention, demonstrating the use of one UAV with a fixed attachment magnetometer and the drilling tool being operated under an approximately planar earth surface area;

FIG. 2 is a side schematic diagram of an alternate embodiment of the system of the present invention demonstrating the use of multiple UAVs with cable suspended magnetometers, and the drilling tool being operated under a watercourse;

FIG. 3 is a block diagram showing the components of one embodiment of a UAV in accordance with the present invention;

FIG. 4 is a block diagram showing the components of one embodiment of a computer in accordance with the present invention;

FIG. 5 is a flowchart illustrating the steps of one embodiment of a method of controlling the position of a subterranean directional drilling tool in relation to a desired subterranean drill bore path in accordance with the present invention;

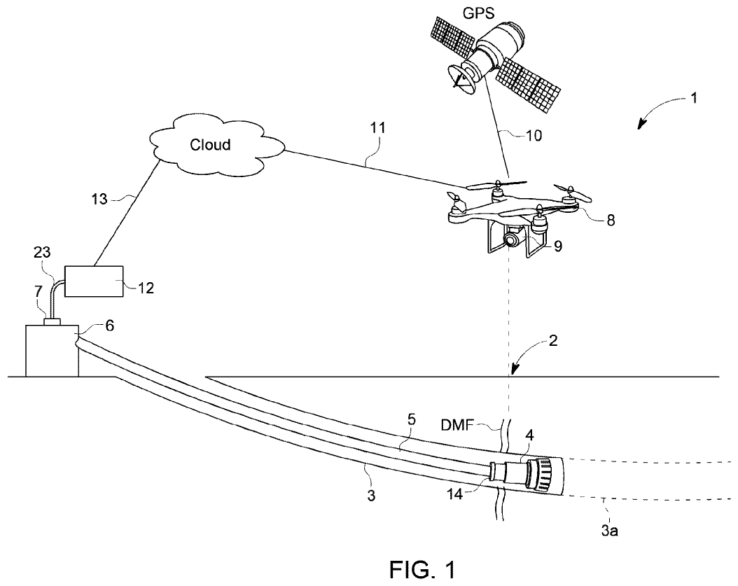

FIG. 1B is a flowchart extending from FIG. 1A and further illustrating the method of controlling the position of a subterranean directional drilling tool in relation to a desired subterranean drill bore path, according to some embodiment s of the present disclosure.

### DETAILED DESCRIPTION

As generally outlined above, the present invention comprises a system and method for the automated or enhanced manual control of a subterranean drilling tool along an optimized or de sired subterranean drill bore path, using a drone assisted magnetic ranging method and apparatus. One or more UAVs or drones, each of which has a triaxial magnetometer attached thereto and is networked to a computer controlling the method, will be used to maintain a best possible up-to-date terrestrial position fix on the drilling tool beneath the surface, and the position of the tool can be compared to the de sired drill path and control inputs in an automated embodiment, or interface indications in a human operated drilling tool environment, can be generated to maintain the direction of the drilling tool.

From a conceptual level the method of the present invention effectively uses a drone based magnetometer to capture a relative position of a magnetic target attached to the drilling tool in relation to the location of the drone, and then resolves a terrestrial location coordinate of the drilling tool based upon a combination of the determined relative position of the drilling tool to the position of the drone, and a GPS position of the drone based on an onboard GPS receiver thereof. The position of the drilling tool itself in relation to the desired drill bore path or vector can then be used to determine any necessary adjustments to the control system of the drilling tool to keep the drilling tool drilling as close as possible to the desired drill bore path. By allowing for ongoing accurate knowledge of the location of the drilling tool, complicated horizontal drilling applications can be optimized, made as safe as possible, and executed at a far higher velocity than prior art approaches where constant shutdowns to arrange and locate the tool are required.

### System Architecture

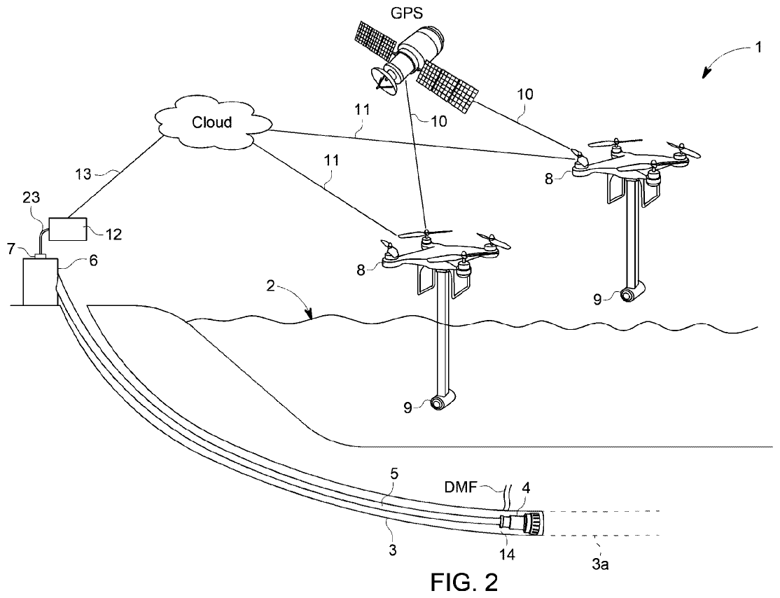

FIGS. 1 and 2 are schematic diagrams of embodiments and operations of the system of the present invention into different scenarios. The embodiment of FIG. 1 shows a system in accordance with the present invention using a single UAV, with the drilling tool being used under a regular earthborn location. The figure shows the Earths surface 2. There is also a subterranean horizontal drilling tool 4, mounted to a rotary shaft 5. The tool is shown in a subterranean drill bore 3, and the desired or estimated forward path of the drill bore in front of the face of the drilling tool 4 is shown 3A. Typical horizontal drilling tools, as shown, further comprise a power unit 6 operatively connected to the shaft 5. There are also components and mechanics of the drilling tool 4 itself as well as the shaft and the remainder of the equipment thereof, connected by wireline or otherwise, which will permit the alteration of the drilling direction of the tool 4 in operation. Basically an operator at the drilling power unit itself can control and adjust the drilling positioning and direction of the tool 4 to adjust the tool 4 and the resulting drill board 3 to follow the desired path. It will be understood that there are many different types of equipment which could be used as a subterranean drilling tool—the general concept of a shaft attached rotary drilling tool as shown is one of many approaches and all are contemplated within the scope of the present invention insofar a s each of them can have their drilling direction control from above ground.

In the system of the present invention, the power unit 6 of the drilling tool comprises a control bus 7, capable of accepting computer or control inputs from a manual control or the computer 12 which is also shown. In the embodiment shown, it is explicitly contemplated that the computer 12, on operation and execution of the method as otherwise outlined, will provide control inputs to the drilling power unit 6 and the remainder of that equipment by the control bus 7 to automatically or in an operator-assisted fashion altered the direction of the drilling tool 4 to follow the desired drilling path. The computer 12 also comprises a network interface 13, which is shown in this Figure as connected to the electronics on the at least one UAV 8 by another network interface 11.

The system also comprises at least one UAV 8 capable of using a magnetometer to detect the position or rotation of the magnetic tool target 14 attached to the drilling tool 4 within the drill bore. The detectable magnetic field produced by the target 14 is shown DMF. As outlined throughout, the concept of the use of a triaxial magnetometer to in a relational fashion detects the position of the target 14 and the drilling tool 4 in relation to the magnetometer 9 of the UAV 8 is well known in the art and is understood to be, in any way, intended within the scope of the present invention.

The UAV 8 includes a triaxial magnetometer 9 capable of detecting the distance and position of the tool target 14 there from, when the UAV 8 is on station at a sensing location. The UAV 8 also includes a GPS module 10 capable of receiving a GPS signal and determining the terrestrial positioning of the UAV 8.

In operation of the system 1, the UAV 8 would be instructed by computer command or by an operator in certain embodiments to take position at a sensing location where from the magnetometer 9 could be used to determine the location of the tool target 14 and by inference the tool itself 4. The magnetometer 9 would be instrumented and connected to the remainder of the electronics on the UAV such that readings captured by the magnetometer 9 could be transmitted to the computer 12. The UAV 8 could remain on station at the sensing location at either on a repeated basis in real time or periodically as required capture a relative position fix of the drilling tool 4, by way of sensing the presence and location of the target 14. The relative di stance and location of the target 14, when transmitted along with the GPS location of the UAV 8 back to the computer 12 can be used in the remainder of the position fixing method of the present invention.

Referring next to the embodiment of FIG. 2, there is shown an alternate embodiment of the system of the present invention which incorporates more than one UAV 8. The embodiment shown in this Figure also demonstrates the utility of the system and method of the present invention where the drilling tool 4 is being used in a drill bore 3 beneath a water course. The surface of the water 2 is shown.

The drilling power unit 6 and related control bus 7, along with the computer element as shown in FIG. 1 are shown. There are two UAVs 8 shown, each of which has its magnetometer 9 suspended by a cable below the body of the UAV 8. As the UAVs are manoeuvred into position at that particular sensing locations over the water surface 2 they can be flown down to a position above the water where the waterproof magnetometer 9 is lowered below the water surface and can thus be closer to the drill bore and the target 14 for more accurate detection and location. The idea of the use of the system in a watercourse like this will be understood to be functional with one UAV 8 or more, but the dual scenario shown would allow for more rapid advancement of the tool 4 and/or more accuracy. It can effectively be seen that the two UAVs 8 used to leapfrog along the surface 2 and re-lower their magnetometers 9 below the water surface to detect the location of the tool 4 as it moves forward.

The embodiment shown in FIG. 2 will work in the same way as FIG. 1 and both approaches will be understood to those skilled in the art as intended to be within the scope of the pre sent invention.

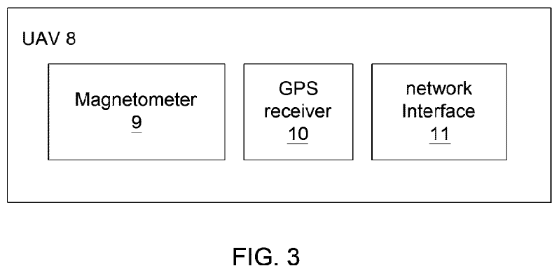

FIG. 3 is a block diagram showing the components of a sample embodiment of a UAV 8 in accordance with the present invention. The general hardware and software components of a UAV 8 will be understood to those skilled in the art, but the key components from the perspective of the present invention as shown are the Sally magnetometer 9, a GPS receiver 10 which can receive a GPS signal indicating the terrestrial location of the UAV 8, as well as a network interface 11 operatively connected to the remainder of the processor and software on the UAV 8 to allow for the capture and transmission of information by the sensors and to the computer 12 operatively connected by a network interface 11.

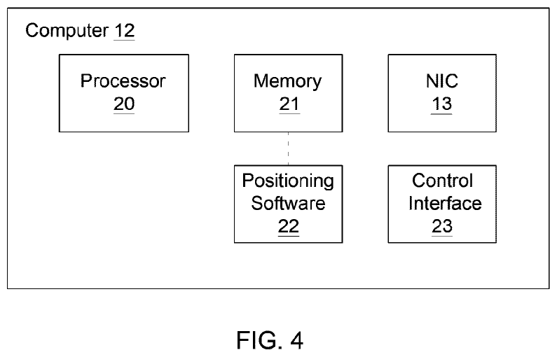

FIG. 4 is a block diagram showing the components of the sample computer 12 in accordance with the remainder of the present invention as outlined. It will be understood to those skilled in the art that many different hardware and software combinations could be used to effectively deliver the method of the present invention and all are contemplated within the scope thereof. In the computer 12 shown in this Figure there is shown a processor 20 as well as a memory 21. The processor 20 in memory 21 along with other basic configuration and components of a typical computer device will be understood to those skilled in the art.

The device also includes a network interface 13 connectable to a network and to communicate with the at least one UAV 8. A control interface 23 is also shown, which would in the embodiments shown transmit control input signals from the computer 12 to the control bus or interface 7 of the drilling power unit 6. Also shown within the or integrated with the memories not 21 is the positioning software component 22, which would comprise the necessary processor instructions for the computer 12, using the data captured by the various interfaces and from the other components of the system to deliver the method and execute the necessary steps thereof.

### Method Overview

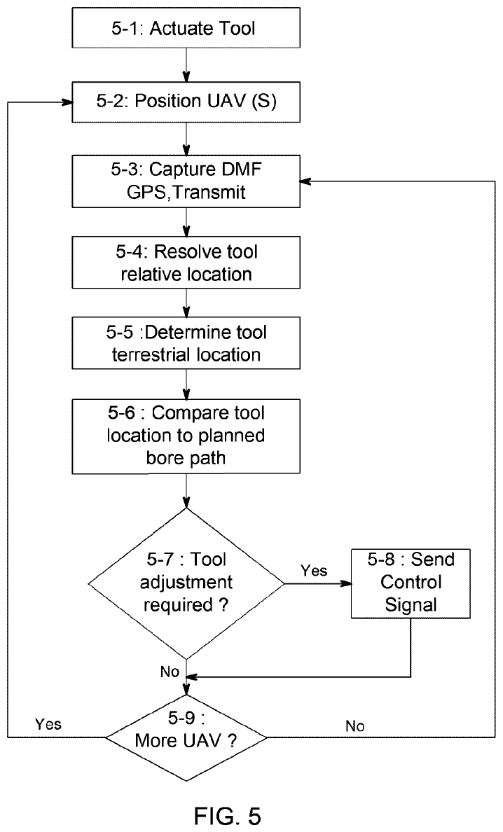

FIG. 5 is a flowchart demonstrating the steps of one embodiment of a method in accordance with the present invention, whereby a drone assisted magnetic ranging system is used to control the position of the subterranean directional drilling tool in relation to a de sired subterranean drill bore path. The method of this Figure could be executed using either the system embodiment of FIG. 1 or 2, or another configuration as might be altered or desired.

In the first step shown, at 5-1, the drilling tool 4 would be actuated using the remainder of the drilling power unit 6 and the drill string 5 etc. The drilling tool 4 and the related power equipment could be actuated once already in position and being restarted within a drill bore, or from a surface position in a starting move. It will be understood that in certain embodiments of the method of the present invention the drilling tool 4 as shown in this step might already be actuated and as such this startup step would be considered optional in terms of the overarching method of the present invention.

Shown next at 5-2, the computer 12 could transmit desired sensing locations to the UAV 8, or the UAV 8 by use of its magnetometer 9 might travel along the preprogrammed door known path of the drilling tool 4, to ascertain a reasonably close location between the magnetometer 9 and the drilling tool target 14. Once it was determined that the UAV 8 was positioned at an appropriate sensing location, either by the onboard electronics of the UAV 8, the computer 12 by virtue of data transmitted back or otherwise, the position of the UAV 8 could be maintained in a hopper or by landing at a particular location for the time period desired to capture data for use in the remainder of the method.

The core of the method of the pre sent invention is related to the drone assisted determination of the terrestrial location of the drilling tool 4, using the at least one UAV 8. At a particular data capture time, the software and hardware on the UAV 8 would capture the details of the detectable magnetic field DMF generated by the tool target 14, the detectable data from which can be used to determine the relative positioning of the target 14 in relation to the magnetometer 9. This data is the detected magnetic field data.

In addition to the detected magnetic field data being captured for transmission from the UAV 8 back to the computer 12, the GPS receiver 10 would also be sampled to provide an accurate GPS fix in terms of the location of the UAV 8. The UAV position data, being the GPS location, could be time coded or time synchronized to the capture of the detected magnetic field data and embodiments of the method of the pre sent invention in which the UAV position data is time synchronized to the detected magnetic field data, and others where they are not, are both contemplated within the scope of the present invention. The capture of the detected magnetic field data and the UAV position data and its transmission back to the computer 12 are shown at step 5-3. As will be explained further below, multiple data sets could be captured from the same sensing location i.e. the UAV 8 could hold in the same sensing location for more than one data fix and that will also be contemplated to be within the scope of the present invention.

On receipt of a transmission from the UAV 8 at the computer 12, the positioning software component 22 will execute the mathematical steps of the location iteration aspect of the invention. Specifically, the received detected magnetic field data will be used to determine the relative location of the drilling tool 4 to the UAV 8 by determining the relative distance and positioning of the target 14 to the magnetometer 9. Various mathematical formulae can be used for this purpose and will be understood to those skilled in the art of magnetic ranging. In any event, determining the relative location of the drilling tool 4 or the tool face, for example, in relation to the UAV 8 can be done by the appropriate mathematics. Resolving the relative location of the drilling tool 4 in relation to the magnetometer 9 of the UAV 8 is shown at step 5-4.

The relative position of the drilling tool 4 in relation to the UAV 8 will then be mathematically combined with the UAV position data matching the detected magnetic field data in question i.e. the relative positioning of the drilling tool 4 will be combined with the known terrestrial location of the related UAV based on the GPS capture, which will yield an accurate terrestrial indication of the subterranean location of the drilling tool 4. Determination of the terrestrial location of the drilling tool 4 is shown at step 5-5.

The next step of the method shown at 5-6 is the comparison of the determined terrestrial location of the drilling tool to the planned drill bore path, by comparing the terrestrially referenced location of the drilling tool to the stored terrestrial drilling coordinates of the de sired subterranean drill bore path and determining any necessary change in operating drilling direction of the drilling tool to maintain the terrestrial drilling position of the tool as closed to the desired drill bore path as possible.

If an adjustment of the positioning or drill direction of the drilling tool 4 is required to maintain the terrestrial drilling position thereof as close to the desired drill bore path as possible, the logic decision of which is shown at block 5-7, the computer 12, via the control interface 23, could send a digital control signal or required interface data to permit the necessary adjustment of the drilling direction or positioning of the tool 4 to most approximately maintain the desired drill bore path (shown at 5-8). The positioning software component 22 could have the necessary logic incorporated therein to provide a complete or finished signal instruction via the interface 23 to the drilling equipment 6, or the control signal which could be sent may need to be effectively finished, calibrated or the like by the software on the PLC or other computer hardware and software resident on or directly operative and connected to the drilling equipment 6. Both such approaches are contemplated within the scope of the present invention.

Following the determination of whether or not any change in drilling direction is required which might mandate the sending of a control signal via step 5-8, the software 22 could also determine whether or not it was desirable at that particular point in time to send a control instruction to the UAV 8 to move its sensing position. A decision block related to whether or not one or more of the at least one UAVs 8 needed to be moved shown at 5-9. If the UAV 8 in question was still insufficient range to accurate and valid magnetic ranging data to the target 14 via its magnetometer 9 the UAV may not be moved, but if it is desired to move it to be closer to the target 14 as the tool continues moving forward through the wellbore, then an instruction might be sent to the drone to move. It will be understood that the UAV could also be manually controlled in certain embodiments, with necessary appropriate user-interface indications or the like, but in a fully automated control system in accordance with the remainder of the present invention not only the dispatch of control signals to the drilling equipment 6 to automatically target or move the direction of drilling of the drilling tool 4 but also the positioning of the UAV or UAVs 8 would all be orchestrated by the computer 12 and the positioning software component 22. Any number of different levels of automation and the process will be understood within the general scope of the method outlined and all are contemplated within the scope of the present invention.

In a case of an embodiment of the system in accordance with FIG. 2 being used i.e. where the magnetometer 9 is suspended from the bottom of a UAV 8 either for use in an underwater sensing and ranging approach or for some other reason, it will be understood that the math used in the positioning software component 22 to ascertain the appropriate positioning and relative location of the drilling tool 4 at the drilling target 14 in relation to the UAV 8 can be adjusted and will all be understood within the scope of the present invention. Any number of different circumstances or environmental variables could be reflected in that algorithm and again all are understood to be within the scope of the present invention as claimed.

Capturing of rapid and repeated location fixes using the method of the present invention can result in the ability to extremely accurately direct the drilling tool without the need for the deployment of human operators in any significant degree in the field in any close proximity to the drilling tool even if the drilling tool is being deployed reasonably close to the surface.

It will be apparent to those of skill in the art that by routine modification the present invention can be optimized for use in a wide range of conditions and application. It will also be obvious to those of skill in the art that there are various ways and designs with which to produce the apparatus and methods of the present invention. The illustrated embodiments are therefore not intended to limit the scope of the invention, but to provide examples of the apparatus and method to enable those of skill in the art to appreciate the inventive concept.

Those skilled in the art will recognize that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. The terms “comprises” and “comprising” should be interpreted as referring to elements, components, or steps in a non-exclusive manner, indicating that the referenced elements, components, or steps may be present, or utilized, or combined with other elements, components, or steps not expressly referenced.

What is claimed is:

1. A method of controlling the position of a subterranean directional drilling tool in relation to a de sired subterranean drill bore path using a system comprising:
a. a directional drilling tool capable of drilling within an as sociated subterranean drill bore, said drilling tool having a control bus capable of receiving control inputs to control the operational drilling direction of the tool;
b. a magnetic tool target attached to the drilling tool for emission of a detectible magnetic field;
c. at least one UAV capable of controllably hovering or landing at a above-ground sensing location and comprising:
i. a tri-axial magnetometer capable of detecting the magnetic field emitted by the magnetic tool target and yielding detected magnetic field data from which the di stance and position of the drilling tool in relation to the UAV can be determined;
ii. a GPS receiver capable of receiving GPS signals identifying the terrestrial location of the UAV, being UAV position data; and
iii. a network interface whereby detected magnetic field data and UAV position data can be transmitted to a computer in operative communication with the control bus of the tool; and
d. a computer comprising:
i. a processor;
ii. a memory storing the terrestrial drilling coordinates of the desired subterranean drill bore path;
iii. a network interface capable of communication with the at least one UAV and receiving data transmitted therefrom;
iv. a control bus connection to the control bus of the drilling tool; and
v. a positioning software component comprising processor instructions by which the computer can facilitate the necessary steps of the method;
said method comprising, by operating the system:
a) actuating the drilling tool to drill in estimated accordance with the stored terrestrial drilling coordinates;
b) positioning each UAV at a selected sensing location in proximity to the intended alignment of the desired subterranean drill bore path, within detection range of the magnetic tool target by the magnetometer;
c) periodically, in respect of each UAV, capturing detected magnetic field data in relation to the magnetic tool target using the magnetometer and the terrestrial location of the UAV using the UAV-based GPS receiver, and transmitting the detected magnetic field data and UAV position data to the computer;
d) in a location resolving step, on receipt of detected magnetic field data by the computer from any of the UAVs:
a. calculating the relative target location of the magnetic tool target in relation to the corresponding magnetometer using the received detected magnetic field data;
b. mathematically combining the UAV position data with the relative target location to yield a terrestrially referenced location of the drilling tool;
c. comparing the terrestrially referenced location of the drilling tool to the stored terrestrial drilling coordinates of the desired subterranean drill bore path and determining any necessary change in operating drilling direction of the drilling tool to maintain the terrestrial drilling position of the tool as closed to the desired drill bore path as possible;
e) if any change in drilling direction is required, providing an as sociated control input to the drilling tool via the control bus; and
f) periodically actuating movement of each UAV to a desireable sensing position along the drill bore path a s the drilling tool advances;
wherein during operation of the system the periodic detection of the drilling tool position and adjustment of the operating drilling direction will result in an optimized adherence of the drilling tool to the desired subterranean drill bore path.

2. The method of claim 1 wherein the number of UAVs is one.

3. The method of claim 1 wherein the number of UAVs is more than one.

4. The method of claim 1 wherein the magnetometer is rigidly attached to the corresponding UAV.

5. The method of claim 1 wherein the magnetometer is flexibly suspended from the corresponding UAV by a cable.

6. The method of claim 5 wherein the subterranean drill bore is beneath a body of water, and the UAV lowers the magnetometer below the surface of the water at the selected sensing location.

7. The method of claim 1 wherein the network interface of a UAV via which data is transmitted to the computer is either:
a. an integrated network interface of the UAV; or
b. a separate network interface module a s sociated with the magnetometer and borne by the UAV.

8. The method of claim 1 wherein the position of the magnetic tool target and the tri-axial magnetometer on the at least one UAV are switched, wherein:
a. each UAV includes a magnetic tool target for emission of a detectible magnetic field;
b. the drilling tool includes a tri-axial magnetometer capable of detecting the magnetic field emitted by the magnetic tool target of the at least one UAV, said magnetometer being connected to the computer to transmit detected magnetic field data thereto; and
c. in the location resolving step of the method, on receipt of detected magnetic field data by the computer from the tool-borne magnetometer, the software will calculate the relative target location of the magnetic tool target in relation to the magnetometer using the received detected magnetic field data and mathematically combine the UAV position data with the relative target location to yield a terrestrially referenced location of the drilling tool.

9. A system for controlling the position of a subterranean directional drilling tool in relation to a desired subterranean drill bore path comprising:
a. a directional drilling tool capable of drilling within an as sociated subterranean drill bore, said drilling tool having a control bus capable of receiving control input s to control the operational drilling direction of the tool;
b. a magnetic tool target attached to the drilling tool for emission of a detectible magnetic field;
c. at least one UAV capable of controllably hovering or landing at a above-ground sensing location and comprising:
i. a tri-axial magnetometer capable of detecting the magnetic field emitted by the magnetic tool target and yielding detected magnetic field data from which the distance and position of the drilling tool in relation to the UAV can be determined;
ii. a GPS receiver capable of receiving GPS signals identifying the terrestrial location of the UAV, being UAV position data; and
iii. a network interface whereby detected magnetic field data and UAV position data can be transmitted to a computer in operative communication with the control bus of the tool; and
d. a computer comprising:
i. a processor;
ii. a memory storing the terrestrial drilling coordinates of the desired subterranean drill bore path;
iii. a network interface capable of communication with the at least one UAV and receiving data transmitted therefrom;
iv. a control bus connection to the control bus of the drilling tool; and
v. a positioning software component comprising processor instructions by which the computer can facilitate the necessary steps of the method;
wherein during operation of the system a method will be executed comprising:
a) actuating the drilling tool to drill in estimated accordance with the stored terrestrial drilling coordinates;
b) positioning each UAV at a selected sensing location in proximity to the intended alignment of the desired subterranean drill bore path, within detection range of the magnetic tool target by the magnetometer;
c) periodically, in respect of each UAV, capturing detected magnetic field data in relation to the magnetic tool target using the magnetometer and the terrestrial location of the UAV using the UAV-based GPS receiver, and transmitting the detected magnetic field data and UAV position data to the computer;
d) on receipt of detected magnetic field data by the computer from any of the UAVs:
a. calculating the relative target location of the magnetic tool target in relation to the corresponding magnetometer using the received detected magnetic field data;
b. mathematically combining the UAV position data with the relative target location to yield a terrestrially referenced location of the drilling tool;
c. comparing the terrestrially referenced location of the drilling tool to the stored terrestrial drilling coordinates of the desired subterranean drill bore path and determining any necessary change in operating drilling direction of the drilling tool to maintain the terrestrial drilling position of the tool as closed to the desired drill bore path as possible;
e) if any change in drilling direction is required, providing an as sociated control input to the drilling tool via the control bus; and
f) periodically actuating movement of each UAV to a desireable sensing position along the drill bore path as the drilling tool advances;
wherein during operation of the system the periodic detection of the drilling tool position and adjustment of the operating drilling direction will result in an optimized adherence of the drilling tool to the desired subterranean drill bore path.

10. The system of claim 9 wherein the number of UAVs is one.

11. The system of claim 9 wherein the number of UAVs is more than one.

12. The system of claim 9 wherein the magnetometer is rigidly attached to the corresponding UAV.

13. The system of claim 9 wherein the magnetometer is flexibly suspended from the corresponding UAV by a cable.

14. The system of claim 13 wherein the subterranean drill bore is beneath a body of water, and the UAV lowers the magnetometer below the surface of the water at the selected sensing location.

15. The system of claim 9 wherein the network interface of a UAV via which data is transmitted to the computer is either:
a. an integrated network interface of the UAV; or
b. a separate network interface module a s sociated with the magnetometer and borne by the UAV.

16. The system of claim 9 wherein the position of the magnetic tool target and the tri-axial magnetometer on the at least one UAV are switched, wherein:
a. each UAV includes a magnetic tool target for emission of a detectible magnetic field;
b. the drilling tool includes a tri-axial magnetometer capable of detecting the magnetic field emitted by the magnetic tool target of the at least one UAV, said magnetometer being connected to the computer to transmit detected magnetic field data thereto; and
c. in the location re solving step of the method, on receipt of detected magnetic field data by the computer from the tool-borne magnetometer, the software will calculate the relative target location of the magnetic tool target in relation to the magnetometer using the received detected magnetic field data and mathematically combine the UAV position data with the relative target location to yield a terrestrially referenced location of the drilling tool.
